(19) United States
(12) Patent Application Publication
(10) Pub. No.: US 2009/0191416 A1
(43) Pub. Date: Jul. 30, 2009

(54) Method for deposition of cemented carbide coating and related articles

(75) Inventor: Andrei Alexander Verstak, Martinez, CA (US)

Correspondence Address: Andrei Verstak, Suite 2, 3900 Oregon Street,, Benicia, CA, 94510, US

(73) Assignee: Kermetico Inc., Benicia, CA (US)

(21) Appl. No.: 12/321,543

(22) Filed: Jan. 22, 2009

Related U.S. Application Data
(60) Provisional application No. 61/062,369, filed on Jan. 25, 2008.

(51) Int. Cl. B32B 15/04; B05D 1/02

(52) U.S. Cl. 428/457; 427/201

(57) ABSTRACT

Quality of high-velocity oxygen- and air-fuel sprayed coatings of cemented carbides is improved by regulating amounts of depositing and non-depositing carbide particles. The non-depositing particles activate the substrate, increasing coating hardness and density.

### CROSS-REFERENCE TO RELATED APPLICATIONS

This application is continuation of provisional application 61/062,369, filed Jan. 25, 2008.

### STATEMENT REGARDING FEDERALLY SPONSORE RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

This invention relates generally to the methods of coating deposition by high-velocity thermal spray techniques, such as high-velocity oxygen-fuel (HVOF) and high-velocity air-fuel (HVAF) spraying. More particularly, the invention is directed for processing of wear, erosion and corrosion resistant coatings of cemented carbides applied to parts of transport machines and industrial equipment.

2. Description of Related Art

Metal surfaces of machines and industrial equipment are frequently subject to severe abrasive wear, erosion and corrosion attack limiting their lifetime and affecting performance, production efficiency and safety. The cylinder and pistons of aircraft landing gear are worn out by abrasive particles entrained under rubber seals and additionally are exposed to corrosion. Abrasive wear is a reason of premature failure of piston rods and plungers of oil processing compressors and pumps. Pump wear rings, impellers and bushing exhibit severe wear due to solid particle erosion and acidic corrosion attack. Impellers and diffusors of electrical submercible pumps, as well as rotors of progressive cavity pumps are worn due to erosion and abrasive wear, coupled with corrosion attack by sulfur-containing gases, acids and chlorides. Gates and seals of gate valve are losing their performance due to wear of contacting surfaces. Rolls in different metal processing mills are subject for abrasive wear and, frequently, corrosion, affecting quality of sheet metal products. Wear of tips of gas turbine blades results in the loss of compression and efficiency of gas turbines. Erosion and corrosion of tubing in pulverized coal and fluidized-bed combustion boilers is a frequent reason for planned and emergency shutdowns. Evidently, improvement of metal surface performance under conditions of wear and corrosion is of great importance for industry, transport and power generation.

Application of coatings was and remains the most efficient way to improve wear and corrosion resistance of critical components of machinery and devices. Cemented carbides, mainly such compositions as tungsten carbide-cobalt, tungsten carbide- nickel, tungsten carbide-cobalt-chrome, chrome carbide-nickel-chrome and tungsten carbide- chrome carbide- nickel-chrome are proven solutions for many listed above problems. The most dense and wear resistant coatings are currently applied using high-velocity oxygen-fuel spraying (HVOF), high-velocity air-fuel spraying (HVAF) and detonation spraying techniques, which belong to the group of high-velocity thermal spray methods.

In several known high-velocity thermal spray methods, cemented carbide coatings are applied using mechanical mixtures (blends) of carbide and metal powders [Ref. 1-5]. To deposit carbides from blends, the spray materials are heated to temperature, high enough to fuse or substantially soften carbides, which is a condition to provide deposition of the carbides in the coating. However, such heating results in partial decomposition of carbides and oxidation. Those affect coating quality, such as hardness and toughness. Additionally, chemical composition of final coating is inconsistent due to different rates of deposition of carbide and metal powders, both dependent on deviation of spray parameters.

Another group of high-velocity thermal spray methods uses composite powders of cemented carbides for coating deposition, where each composite powder particle contains carbide grains and metal alloy binder [Ref. 6-12]. Alternatively, carbide grains are plated by metal [Ref 13]. The use of composite powders decreases decomposition and oxidation of carbides, this way improving coating quality and its consistency. However, the coating mechanical properties and wear resistance are still much lower than those achieved in so called sintered cemented carbides, representing maximal level of material quality presently achievable. The coatings remain porous, resulting in their insufficient corrosion resistance and/or sealing properties.

Partial decomposition of tungsten carbide (WC) is practically unavoidable when using relatively hot gaseous jets, generated in HVOF and in detonation spraying techniques. During WC decomposition, released carbon and tungsten diffuse into metal matrix, making coating harder but more brittle, compromising coating toughness and consequently decreasing coating resistance to abrasive wear, erosion and fatigue. An improvement in cemented carbide coating toughness is achieved when reducing spray particle temperature by using HVAF spraying [Ref. 14-16]. However, this does not noticeably reduce coating porosity neither improves mechanical properties, such as cohesion strength and hardness, necessary for high wear and corrosion resistance.

Therefore, a need exists for cemented carbide coatings with high hardness and density, which are achieved without compromising toughness, to provide necessary protection for machine parts and devices working in harsh conditions of severe wear and corrosion.

### BRIEF SUMMARY OF THE INVENTION

To retain toughness (ductility) of cemented carbide material in the coating, in present invention it is applied with high-velocity air-fuel (HVAF) spraying or high-velocity oxygen-fuel (HVOF) spraying when oxygen is partially replaced with air to decrease combustion temperature. The composite powder is used, each particle of the composite powder containing grains of carbide material and metallic alloy. In the spray gun, those composite powder particles are heated and accelerated sufficiently enough to form a coating layer upon their impact with the substrate, but not high enough to cause decomposition of the carbide material or oxidation of the carbide material or metallic alloy, this way avoiding coating embrittlement. Preferably, composite powder particles are heated near or slightly above melting temperature of the metallic alloy. In order to improve bonding of the composite powder particles, thus, its strength and hardness, as well as coating density, additional carbide powder particles are fed into the gun. The additional carbide powder particles do not contain any metallic alloy. In the gun, these particles are heated and accelerated sufficiently enough to activate the substrate upon impact and to remove poorly bonded composite particles of the coating, but not sufficiently enough to deposit on the substrate neither to damage already formed coating.

To provide efficient activation of the substrate and removal of poorly bonded particles without damaging a coating, the additional carbide powder particles are chosen of specific composition, size and concentration in a spray jet. It is preferable that additional carbide powder particles to be essentially of the same composition as the carbide material in the composite powder. This way the additional carbide particles would not contaminate the coating.

When the carbide material in the composite powder is tungsten carbide, and the metallic alloy is cobalt-, nickel- or iron-based alloy, then the carbide material of the additional carbide powder is tungsten carbide with particle size from 1 to 20 micron, preferably from 2 to 10 micron, and the amount of the additional carbide particles is greater than 30% of the total amount of particles fed into the gun, preferably 33-50%.

When the carbide material in the composite powder is chrome carbide, and the metal alloy material is nickel- or iron-based alloy, then the carbide material of the additional carbide powder is chrome carbide with particle size from 5 to 63 micron, preferably from 5 to 30 micron, and the amount of the additional carbide particles is greater than 20% of the total amount of particles fed into the gun, preferably 25-50%.

When the carbide material in the composite powder consists of more than one carbide selected from a group of tungsten, chromium, titanium, boron, silicon, molybdenum, vanadium, zirconium and hafnium carbide or composition thereof, then the carbide material of the additional carbide powder is one or more of the carbides from this group or composition thereof.

The additional carbide powder particles are fed into the spray gun as a mechanical blend with the composite powder or are fed into the spray gun with a separate powder feeder.

### BRIEF DESCRIPTION OF THE SEVERAL VIEWS OF THE DRAWING

Not Applicable

### DETAILED DESCRIPTION OF THE INVENTION

During thermal spraying of coatings, the formation of bonds between spray particles and a substrate, or bonding, determines coating strength, hardness and porosity. The bonding is a multi-step process, including a strict sequence of the following steps:
1) formation of physical contact between the surface of the spray particle and the surface of the substrate during deformation of spray particle upon impact;
2) activation of the substrate, such as weakening and destruction of old surface bonds in point-like centers (active centers) located in the area of physical contact; active centers are formed due to thermal fluctuation of atoms and movement of dislocations to the substrate surface, both induced by heating and impact stresses from the spray particle; it is understood that the surface of the spray particle is active since it is heated to relatively high temperature;
3) formation of new bonds between the spray particle and the substrate in active centers;
4) growth of active centers due to inter-surface diffusion and volume diffusion.

It is understood that for majority thermal spray methods, including high-velocity spray techniques such as HVOF and HVAF, the step #2 (activation of the substrate) is a limiting step of the whole bonding reaction. Accelerating this step would increase bonding of the spray particles to the substrate efficiently, improving coating strength.

It is also understood that limiting the spray particle temperature to near its melting temperature efficiently reduces spray material oxidation and thermal deterioration, since both of those phenomena are controlled by mass transition—and this is thousand times faster in liquids than in solids. Thus, avoiding fusion of metallic component in composite powder of the cemented carbide is a very efficient way of preventing oxidation of both metal and carbide material, as well as in preventing thermal decomposition of the carbide material during coating spraying. This ensures that the coating materials would not be embrittled, and its toughness not compromised.

An efficient way of reducing cemented carbide particle temperature during HVOF spraying is partial or complete replacement of oxygen with air (performing air-fuel spraying). It is possible since combustion temperature of air-fuel mixtures is by 1000 degrees C lower than the one of oxygen-fuel mixtures, and only slightly exceeds melting temperature of common metallic alloys used in cemented carbide coatings. Thus, in the present invention, HVAF or HVOF with partial replacement of oxygen with air are preferable techniques for deposition of tough cemented carbide coatings.

In the present invention, the composite powder is used for coating spraying, each particle of the composite powder containing grains of carbide material and metallic alloy. In the spray gun, those composite powder particles are heated and accelerated sufficiently enough to form a coating layer upon their impact with the substrate, but not high enough to cause decomposition of the carbide material or oxidation of the carbide material or metallic alloy, this way avoiding coating embrittlement. It s our understanding that ideal heating temperature of the cemented carbide powder particle is the temperature near melting point of its metallic alloy component. However, since large deviation of particle size in commercial spray powders, it is practically impossible to heat all the particles to the same temperature. Thus, the surface of some of them (those of smaller size) could be overheated 50-100 degrees C. over metal melting point. Preferably, all the spray particles are accelerated to velocity over 500 m/s to provide their bonding at such reduced temperatures.

It is also our understanding that reduced temperature of spray composite powder particles decreases thermal effect of the particle on the substrate, slowing down activation of the substrate (step 2 in described above sequence of bonding), thus negatively affecting coating strength, hardness and density. In order to improve bonding of the composite powder particles, additional carbide powder particles are fed into the gun. The additional carbide powder particles do not contain any metallic alloy. In the gun, these particles are heated and accelerated sufficiently enough to activate the substrate upon impact and to remove poorly bonded particles of the coating, but not sufficiently enough to deposit on the substrate neither to damage already formed coating.

Activation of the substrate upon impact of additional carbide powder particle happens due to (a) heating of the substrate in the impact zone by a hot carbide particle, (b) creating additional active dislocations at the substrate surface due to the stress induced by the impact and (c) destruction of old bonds on the substrate surface in the impact area. The time the substrate remains “active” is rather short (0.01 second or less), thus it is important simultaneous feed of the composite and additional carbide powders into the spray jet. When the composite powder particle strikes such active surface during spraying, the step 2 of bonding reaction (activation of the substrate by creating active centers) goes faster and more active centers are formed. As a result, bonding of the composite powder particle to the substrate is improved. Consequently, coating strength, hardness and density are improved, too.

Besides activation of the substrate, the powerful impact of additional carbide powder particles removes those composite powder particles, which were bonded to the substrate not well enough to withstand such impact. This way, the sources of possible coating defects (pores and cracks) are removed—the additional carbide powder particles “check” the coating quality while it is in a process of formation. It is evident, that thermal and kinetic energy of the additional carbide particles should not be too high to destroy the coating.

To provide efficient activation of the substrate and removal of poorly bonded particles without damaging the coating, the additional carbide powder particles are chosen of specific composition, size and concentration in a spray jet. It is preferable that additional carbide powder particles to be essentially of the same composition as the carbide material in the composite powder. It ensures that the thermal and kinetic energy of the additional carbide particles are comparable (i.e., not very different) with the spray composite powder particles. It also eliminates possible contamination of the coating with other materials.

The additional carbide powder particles are fed into the spray gun as a mechanical blend with the composite powder. Alternatively they are fed into the spray gun with a separate powder feeder. In the latter case the additional carbide powder particles can be fed into the spray gun or spray jet at different location than the location of the composite powder feeding in order to adjust the energy of the additional carbide particles.

In one of the preferred embodiments, the carbide material in the composite powder is tungsten carbide, and the metallic alloy is cobalt-, nickel- or iron-based alloy. The carbide material of the additional carbide powder is tungsten carbide with particle size from 1 to 20 micron, preferably from 2 to 10 micron, and the amount of the additional carbide particles is greater than 30% of the total amount of particles fed into the gun, preferably 33-50%.

In the other preferred embodiment, the carbide material in the composite powder is chrome carbide, and the metal alloy material is nickel- or iron-based alloy. The carbide material of the additional carbide powder is chrome carbide with particle size from 5 to 63 micron, preferably from 5 to 30 micron, and the amount of the additional carbide particles is greater than 20% of the total amount of particles fed into the gun, preferably 25-50%.

In the next preferred embodiment, the carbide material in the composite powder consists of more than one carbide, selected from a group of tungsten, chromium, titanium, boron, silicon, molybdenum, vanadium, zirconium and hafnium carbide or composition thereof. The carbide material of the additional carbide powder is one or more of the carbides from this group or composition thereof, and the amount of the additional carbide particles is greater than 30% of the total amount of particles fed into the gun.

It is understood, that for economical reasons the additional carbide powder material may have larger deviations in phase and chemical composition, then carbide material in the composite powder, as well as have noticeable impurities. Furthermore, in certain cases the additional carbide powder material may be partially or completely replaced with other material than the carbide in the composite powder, provided that some degree of the coating contamination with debris of such material is acceptable. Also, to improve impact strength of the material of the additional carbide powder, it may be alloyed with other elements, or its structure and phase composition, as well as grain size modified.

The articles with cemented carbide coating, applied with the present invention, are parts of aircraft landing gear; compressor piston rods and plungers; pump parts such as impellers, diffusors, rotors, wear rings and bushings; valve parts such as seals, balls and gates; metal processing rolls, such as sink roll in continuous galvanizing line, tower roll, bridle roll; corrugating paper machine roll; tips of gas turbine blades; superheater and waterwall tubing of fluidized-bed combustion boiler; flites of ash auger and others. The present invention is especially beneficial for depositing coating onto sophisticated shape parts, where different angles of spraying and reflection of the spray jet to adjacent surfaces are not avoidable.

### EXAMPLE

Coatings were sprayed with agglomerated/sintered composite powder of nominal composition (wt. %) 86% WC-9% Co-1% Ni-4% Cr (tungsten content 79.8 wt. %, wet chemistry method), particle size 5-30 micron. The AcuKote HVAF spray system (Kermetico Inc., USA) was used for coatings deposition with standard parameters onto test coupons of carbon steel AISI 1018, size 75×25×6 mm. The composite powder was premixed with different amounts of additional tungsten carbide powder, containing 99.8% WC, particle size 2-10 micron, before spraying. All coatings were applied at similar conditions to thickness 0.40-0.50 mm. After surface grinding, Rockwell harness of coatings was measured with Model 6669 MHC hardness tester, loading on diamond pyramid 60 kg. The content of tungsten in composite powder and sprayed coatings was controlled with wet chemistry method. Coating porosity was determined on coating cross-sections within 5 frames with optical metallography, magnification 200. The test results are presented in the Table 1.

TABLE 1
Composition of spray mixtures and properties of WC—Co—Cr coatings

| | Amount of | | | |
|---|---|---|---|---|
| | additional | | | |
| | tungsten carbide | Content of | | |
| Run | powder in spray | tungsten in | Coating | Coating |
| # | mixture, wt. % | coating, wt. % | hardness, HR | porosity, % |
| 1 | None | 80.0 | 81 | 0.9 |
| 2 | 10 | 79.8 | 80 | — |
| 3 | 20 | 79.9 | 82 | 0.8 |
| 4 | 33 | 79.8 | 92-94 | <0.2 |
| 5 | 50 | 80.0 | 93-94 | <0.2 |

According to data, presented in Table 1, all additions of tungsten carbide powder to spray mixture did not change the amount of deposited tungsten compared to initial tungsten in the composite powder. The additions of tungsten carbide powder up to 20 percent did not change coating hardness and density. However, when the amount of additional tungsten carbide was 33 and 50 percent, as proposed in the present invention, the coating hardness and density was improved noticeably.

What is claimed is:

1. Method for deposition of cemented carbide coating to metal substrate, which comprises the following steps:
a) feeding composite powder particles into high-velocity thermal spray gun, each composite powder particle containing grains of carbide material and metal alloy;
b) heating and accelerating said composite powder particles in the gun sufficiently enough to form a coating layer upon their impact with the substrate, but not high enough to cause decomposition of the carbide material or oxidation of the carbide material or metal alloy,
c) simultaneously feeding additional carbide powder particles, not containing metal alloy, into the gun,
d) heating and accelerating said additional carbide powder particles sufficiently enough to activate the substrate and to remove poorly bonded particles of the coating, but not sufficiently enough to deposit on the substrate neither to damage already formed coating.

2. The method of claim 1, wherein the additional carbide powder particles are essentially of the same composition as the carbide material in the composite powder.

3. The method of claim 1, wherein the composite powder and the additional carbide powder particles are fed into the gun as a mechanical mixture of said two powders.

4. The method of claim 1, wherein the composite powder and the additional carbide powder particles are fed into the gun by separate powder feeders.

5. The method of claim 1, wherein the carbide material in the composite metal alloy- carbide powder is tungsten carbide, and the metal alloy is cobalt-, nickel- or iron-based alloy, and wherein the carbide material of the additional carbide powder is tungsten carbide with particle size from 1 to 20 micron, preferably from 2 to 10 micron, and the amount of the additional carbide particles is greater than 30% of total amount of particles fed into the gun, preferably 33-50%.

6. The method of claim 1, wherein the carbide material in the composite metal alloy- carbide powder is chrome carbide, and the metal alloy material is nickel- or iron-based alloy, and wherein the carbide material of the additional carbide powder is chrome carbide with particle size from 5 to 63 micron, preferably from 10 to 45 micron, and the amount of the additional carbide particles is greater than 15% of total, amount of particles fed into the gun, preferably 20-50%.

7. The method of claim 1, wherein the carbide material in the composite powder consists of more than one carbide selected from a group of tungsten, chromium, titanium, boron, silicon, molybdenum, vanadium, zirconium and hafnium carbide or composition thereof, and the carbide material of the additional carbide powder is one or more of the carbides from this group or composition thereof.

8. Metal article, at least part of the surface of which contains cemented carbide coating applied with the following steps:
a) feeding composite powder particles into high-velocity thermal spray gun, each composite powder particle containing grains of carbide material and metal alloy;
b) heating and accelerating said composite powder particles in the gun sufficiently enough to form a coating layer upon their impact with the substrate, but not high enough to cause decomposition of the carbide material or oxidation of the carbide material or metal alloy,
c) simultaneously feeding additional carbide powder particles, not containing metal alloy, into the gun,
d) heating and accelerating said additional carbide powder particles sufficiently enough to activate the substrate and to remove poorly bonded particles of the coating, but not sufficiently enough to deposit on the substrate neither to damage already formed coating.
